(19) United States
(12) Patent Application Publication
(10) Pub. No.: US 2014/0308905 A1
(43) Pub. Date: Oct. 16, 2014

(54) Flexible Configuration of Channel Measurement

(71) Applicants: De Shan Miao, Beijing (CN); Peter Skov, Beijing (CN); Xiaoyi Wang, Wheeling, IL (US)

(72) Inventors: De Shan Miao, Beijing (CN); Peter Skov, Beijing (CN); Xiaoyi Wang, Wheeling, IL (US)

(73) Assignee: Nokia Solutions and Networkds Oy, Espoo (FI)

(21) Appl. No.: 14/356,633

(22) PCT Filed: Nov. 7, 2011
(86) PCT No.: PCT/CN2011/081875

§ 371 Date: May 7, 2014

(51) Int. Cl. H04W 24/10

(52) U.S. Cl. CPC H04W 24/10
USPC 455/67.11

(57) ABSTRACT

There are provided measures for flexible configuration of channel measurement, particularly in CoMP communication and/or CoMP-enabled heterogeneous network deployments. Such measures may exemplarily include acquiring one or more reference signal patterns for channel measurement, each reference signal pattern defining a predefined number of ports subject to channel measurement, configuring a channel measurement set for a terminal by selecting ports out of the acquired one or more reference signal patterns and combining the selected ports in at least two channel measurement patterns, and instructing channel measurements at the terminal based on the at least two channel measurement patterns in the configured channel measurement set.

### FIELD

The present invention relates to flexible configuration of channel measurement. More specifically, the present invention exemplarily relates to measures (including methods, apparatuses and computer program products) for flexible configuration of channel measurement in coordinated multi-point communication.

### BACKGROUND

The present specification basically relates to channel measurement in coordinated multi-point (CoMP) communication, particularly in CoMP-enabled heterogeneous network deployments.

In the following, for the sake of intelligibility, LTE (Long-Term Evolution according to 3GPP terminology) or LTE-Advanced is taken as a non-limiting example for a (radio access) network deployment being applicable in the context of the present invention specification. However, it is to be noted that any kind of (radio access) network deployment may likewise be applicable, as long as it exhibits comparable features and characteristics as described hereinafter.

Coordinated multi-point (CoMP) transmission and reception is one of technologies being investigated to enhance specifically the capacity and cell-edge data rates in order to create a more uniform data rate experience for the end user over an entire cell area. The CoMP technique basically involves an increased collaboration between different transmission/reception points (e.g. eNBs, RRHs, hotspots, home eNBs etc.) in downlink (DL) transmissions to an UE and uplink (UL) receptions from an UE.

As the currently specified CoMP technique includes different specific transmission schemes/modes, including Joint transmission (JT), dynamic point selection (DPS) and coordination scheduling/coordination beamforming (CS/CB), different feedback schemes/modes are required to harvest the CoMP's performance gain.

Specific scenarios being investigated in the context of CoMP relate to heterogeneous network deployments.

Generally, heterogeneous network deployments, also referred to as multi-layer cellular network systems, comprise a combination of macro cells and micro cells (also referred to as pico cells or femto cells). Thereby, the macro cells (having high transmission power) typically provide for a large geographical coverage, while the micro cells (having low transmission power) typically provide for additional capacity of low geographical coverage in areas with a high user deployment. In the context of LTE or LTE-Advanced, the macro cells are typically deployed by transmission points denoted as base stations or eNBs, while micro cells are typically deployed by transmission point denoted as home base stations (HNB, HeNB), mobile or fixed relay nodes (RN, MR), remote radio heads (RRH) or the like. Examples of heterogeneous network deployments exemplarily include relay-enhanced access networks, and the like.

In such heterogeneous network deployments, the micro cell transmission points (e.g. implemented by the RRHs) may have the same cell IDs as the corresponding macro cell transmission point (e.g. implemented by the eNB), or the micro cell transmission points (e.g. implemented by the RRHs) may have and the corresponding macro cell transmission point (e.g. implemented by the eNB) may have different cell IDs. That is to say, in a CoMP framework, geographically separated transmission points (i.e. antennas thereof) may be configured with different cell IDs, and/or neighboring but geographically separated transmission points (i.e. antennas thereof) may be configured with the same cell ID.

For realizing an appropriate channel measurement in coordinated multi-point (CoMP) communication, particularly in CoMP-enabled heterogeneous network deployments, some flexibility is required in channel measurement configuration for addressing and coping with the above-outlined characteristics of CoMP and heterogeneous network deployments. In this regard, a measurement configuration and/or feedback design with flexibility and simplicity is desirable in order to enable harvesting of the CoMP's performance gain under various feasible CoMP transmission schemes/modes and scenarios of heterogeneous network deployments.

In view thereof, there is a need to provide for improvements in the context of, thus facilitating, flexible configuration of channel measurement, particularly flexible configuration of channel measurement in CoMP and/or CoMP-enabled heterogeneous network deployments.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising acquiring one or more reference signal patterns for channel measurement, each reference signal pattern defining a predefined number of ports subject to channel measurement, configuring a channel measurement set for a terminal by selecting ports out of the acquired one or more reference signal patterns and combining the selected ports in at least two channel measurement patterns, an instructing channel measurements at the terminal based on the at least two channel measurement patterns in the configured channel measurement set.

According to an exemplary aspect of the present invention, there is provided a method comprising receiving, from a transmission point, an instruction for channel measurements on the basis of a channel measurement set, and performing the instructed channel measurements based on at least two channel measurement patterns in the channel measurement set, each channel measurement pattern including a number of ports from one or more reference signal patterns for channel measurement, which are subject to channel measurement.

According to an exemplary aspect of the present invention, there is provided an apparatus comprising an interface configured to communicate with at least another apparatus, a processor configured to cause the apparatus to perform: acquiring one or more reference signal patterns for channel measurement, each reference signal pattern defining a predefined number of ports subject to channel measurement, configuring a channel measurement set for a terminal by selecting ports out of the acquired one or more reference signal patterns and combining the selected ports in at least two channel measurement patterns, and instructing channel measurements at the terminal based on the at least two channel measurement patterns in the configured channel measurement set.

According to an exemplary aspect of the present invention, there is provided an apparatus comprising an interface configured to communicate with at least another apparatus, a processor configured to cause the apparatus to perform: receiving, from a transmission point, an instruction for channel measurements on the basis of a channel measurement set, and performing the instructed channel measurements based on at least two channel measurement patterns in the channel measurement set, each channel measurement pattern including a number of ports from one or more reference signal patterns for channel measurement, which are subject to channel measurement.

Advantageous further developments or modifications of the aforementioned exemplary aspects of the present invention are sett out in the following description.

According to an exemplary aspect of the present invention, there is provided a computer program product including comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

By way of exemplary embodiments of the present invention, there is provided flexible configuration of channel measurement. More specifically, by way of exemplary embodiments of the present invention, there are provided measures and mechanisms for flexible configuration of channel measurement in coordinated multi-point communication, particularly in CoMP-enabled heterogeneous network deployments.

Thus, improvement is achieved by methods, apparatuses and computer program products enabling flexible configuration of channel measurement in coordinated multi-point communication, particularly in CoMP-enabled heterogeneous network deployments.

### BRIEF DESCRIPTION OF THE DRAWINGS

In the following, the present invention will be described in greater detail by way of non-limiting examples with reference to the accompanying drawings, in which

FIG. 1 shows a schematic diagram of a heterogeneous network deployment, for which exemplary embodiments of the present invention are applicable,

FIG. 2 shows a schematic diagram illustrating a basic procedure according to exemplary embodiments of the present invention,

FIG. 3 shows a schematic diagram illustrating an enhanced procedure according to exemplary embodiments of the present invention,

FIG. 4 shows a schematic diagram illustrating various mappings of reference signal patterns in a resource space according to exemplary embodiments of the present invention, and

FIG. 5 shows a schematic diagram of apparatuses according to exemplary embodiments of the present invention.

### DETAILED DESCRIPTION OF EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, an LTE network and corresponding standards (LTE releases 8, 9 and LTE-Advanced release 10 and beyond) are used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, the present invention and its embodiments may be applicable in any heterogeneous (cellular) system, in particular CoMP-enabled heterogeneous network deployments. The present invention and its embodiments may be applicable for/in any kind of modern and future communication network including any conceivable mobile/wireless communication networks according to 3GPP or IETF specifications.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided measures and mechanisms for flexible configuration of channel measurement in coordinated multi-point (CoMP) communication, particularly in CoMP-enabled heterogeneous network deployments.

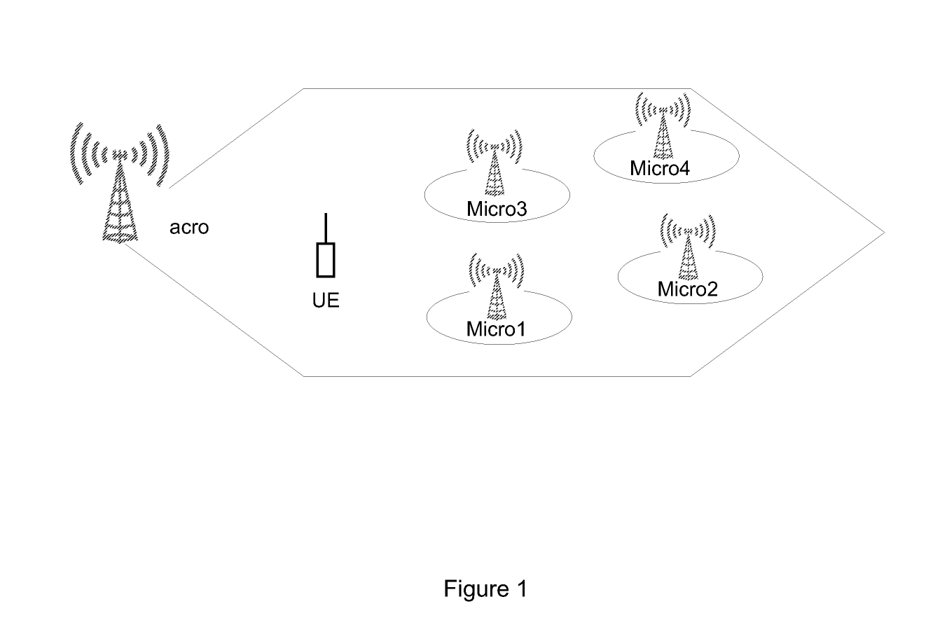

FIG. 1 shows a schematic diagram of a heterogeneous network deployment, for which exemplary embodiments of the present invention are applicable.

As shown in FIG. 1, without limiting generality, it may exemplarily be assumed that four micro-cell type transmission points (e.g. RRHs) are included in the coverage area of a macro-cell type transmission point (e.g. eNB). Both the macro-cell and micro-cell type transmission points may have multiple (transmit/receive) antennas, thus enabling MIMO operation. The macro cell coverage area with the included micro cell coverage areas may be referred to as a CoMP coordination area.

In such scenario, each of the micro-cell type transmission points can form a DL cell of their own, when each having a distinct cell ID, or appear as DL antenna ports of single cell, when each having the same cell ID. From an UL point of view, the concept of a cell is rather different than in the DL, especially when cells are part of the single CoMP coordination area. In the UL, the “cell” rather defines the RS sequence or sequence group and the randomization patterns to be used in the transmission of data and control signals. A transmission point having x antennas may be regarded as having a respective number of x CSI-RS (antenna) ports configured.

The individual micro-cell type transmission points may or may not have the same cell ID (identity) as the macro-cell type transmission point. In a conventional heterogeneous networks scenario, the micro-cell type transmission points are cells of their own, each having a distinct cell ID. In case of (single-cell) CoMP, several transmission points/nodes such as the micro-cell type transmission points as well as the macro-cell type transmission point, possibly having different transmission powers, share the same physical cell-ID and are only to be distinguished by the UE by different CSI-RS.

In LTE Release-10, the concept of CSI-RS (channel state information—reference signals) is introduced. The idea is to transmit separate cell specific (common) RS for CSI estimation purposes in some selected subframes with, e.g., 10 ms (millisecond) periodicity. The UE estimates the CSI (“CSI measurement”) based upon the CSI-RS transmitted by the eNB, and transmits the CSI feedback (“CSI report”) to the eNB, which in turn can use the CSI e.g. in the selection of the precoder for the data.

In addition to the CSI-RS transmission for one cell (e.g. a macro cell), the LTE Release-10 also provides a possibility to configure other CSI-RS patterns (e.g. sets of resource elements) with zero transmit power. These patterns are signaled to the UE via muting patterns, and these indicate which CSI-RS patterns are configured within the area of interest and which of the resource elements the eNB will leave empty when transmitting data on the PDSCH. By way of such UE-specific CSI-RS configurations (also referred to as zero power CSI-RS bitmap or CSI-RS muting pattern), the UE can be configured to only use part of the CSI-RS ports configured in the cell. For the rest of the ports, the UE can be configured to consider these as zero transmit power ports.

Typically, the muting pattern comprises a pattern of bits, wherein each of the bits indicates a predefined number of resource elements (or ports) depending on the number of CSI-RS antenna ports configured within the relevant area. For example, in case of a transmission point in question having four antennas, each bit in the muting pattern indicates a set of four resource elements (or ports) in a resource space, e.g. OFDM symbols occurring at a particular time and on a particular subcarrier in a time-frequency resource space.

The above-outlined channel measurement technique on the basis of a CSI-RS configuration according to LTE Release-10 exhibits certain deficiencies and drawbacks.

For example, a number of CoMP transmission schemes/modes are not supported with the existing UE CSI feedback schemes.

Further, neither inter-/cross-cell channel measurements based on CSI-RS ports belonging to different cells nor intra-cell parallel (multiple) channel measurements within one cell for one UE are feasible.

At least partly, such deficiencies and drawbacks are due to the concept that cell specific messages (using the cell ID as basic identifier) are employed in existing the CSI-RS configuration.

Herein, when reference is made to channel measurement, this encompasses channel state measurement (which yields, as a result, channel state information CSI or the like) and/or channel quality measurement (which yields, as a result, a channel quality indicator CQI or the like). Further, in a channel state measurement, a CQI may also be yielded as a result, since a CQI may be regarded as a specific example of channel state information CSI.

According to exemplary embodiments of the present invention, there is basically provided a flexible and simple CSI measurement configuration capable of overcoming the aforementioned deficiencies and drawbacks.

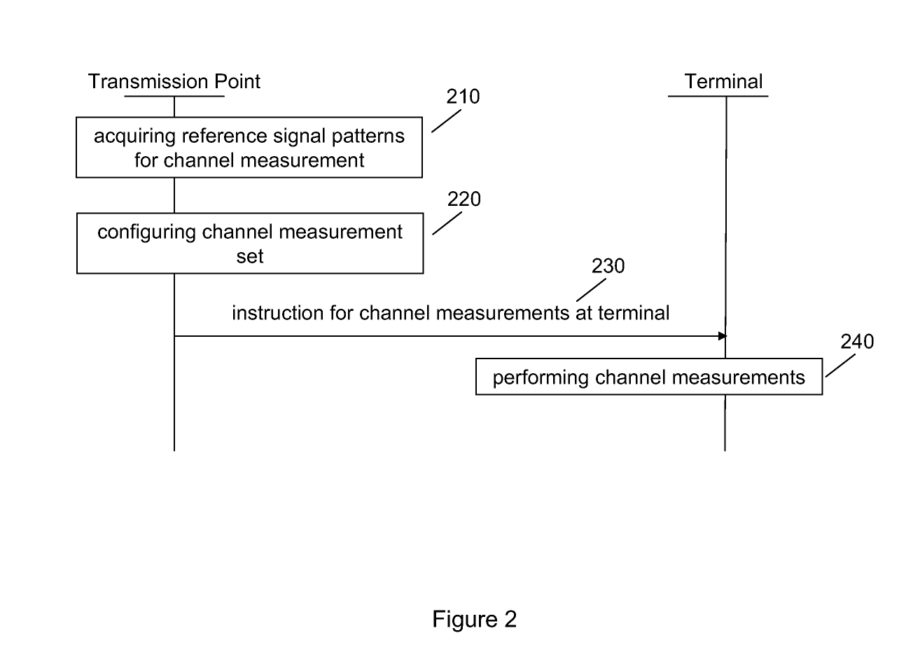

FIG. 2 shows a schematic diagram illustrating a basic procedure according to exemplary embodiments of the present invention. The thus illustrated procedure may be carried out in cooperation between a transmission point such as a macro or micro base station (e.g. eNB) and a terminal (e.g. UE).

As shown in FIG. 2, a corresponding procedure at the transmission point side according to exemplary embodiments of the present invention comprises an operation (210) of acquiring one or more reference signal patterns for channel measurement, each reference signal pattern defining predefined number of ports subject to channel measurement, an operation (220) of configuring a channel measurement set for the terminal by selecting ports out of the acquired one or more reference signal patterns and combining the selected ports in at least two channel measurement patterns, and an operation (230) of instructing channel measurements at the terminal based on the at least two channel measurement patterns in the configured channel measurement set.

As shown in FIG. 2, a corresponding procedure at the terminal side according to exemplary embodiments of the present invention comprises an operation (230) of receiving, from the transmission point, an instruction for channel measurements on the basis of a channel measurement set, and an operation (240) of performing the instructed channel measurements based on at least two channel measurement patterns in the channel measurement set, each channel measurement pattern including a number of ports from one or more reference signal patterns for channel measurement, which are subject to channel measurement.

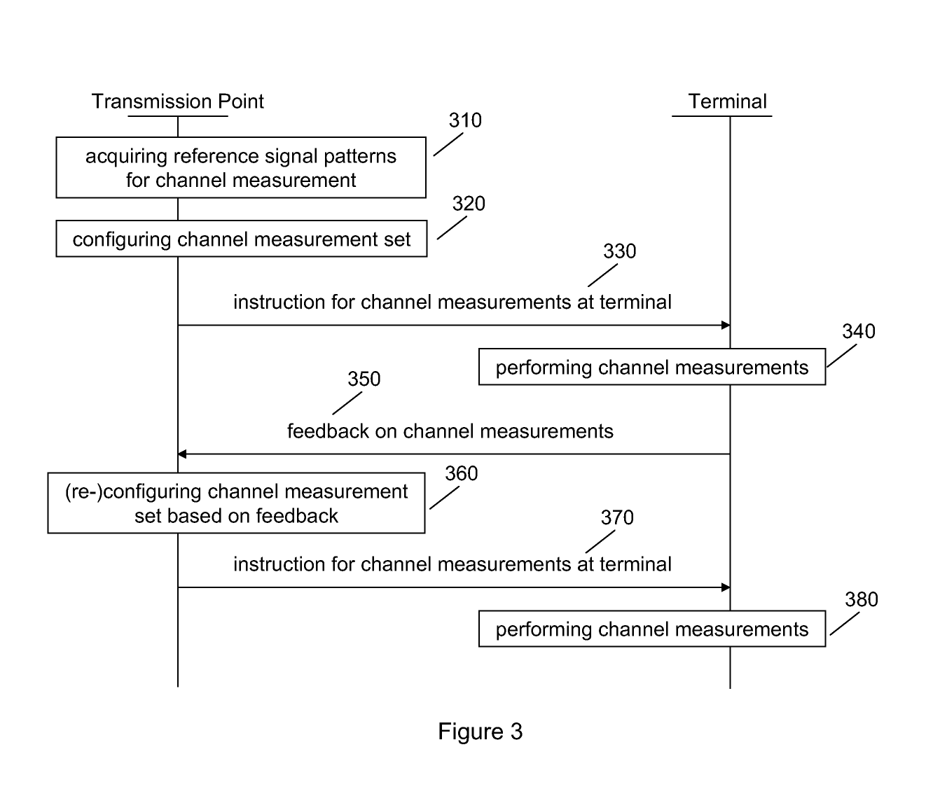

FIG. 3 shows a schematic diagram illustrating an enhanced procedure according to exemplary embodiments of the present invention. Similar to FIG. 2, the thus illustrated procedure may be carried out in cooperation between a transmission point such as a macro or micro base station (e.g. eNB) and a terminal (e.g. UE).

The operations 310 to 340 in FIG. 3 correspond to the operations 210 to 240 in FIG. 2, and reference is made to the above for the description thereof.

As shown in FIG. 3, a corresponding procedure according to exemplary embodiments of the present invention may additionally comprise an operation (350) of sending feedback regarding the instructed (and performed) channel measurements from the terminal to the transmission point, and an operation (360) of (re-)configuring the channel measurement set based on the received feedback at the transmission point. Then, in a corresponding operation (370), the transmission point can again instruct the terminal to perform channel measurements based on the at least two channel measurement patterns in the (re-)configured channel measurement set, and the terminal can, upon receipt of such instruction in the corresponding operation (380), perform the instructed channel measurements based on at least two channel measurement patterns in the (re-)configured channel measurement set.

As indicated above, a channel measurement set or pattern may relate to a channel state measurement set or pattern and/or a channel quality measurement set or pattern.

In the following, details and specifics of the aforementioned operations of the procedures in FIGS. 2 and 3 are described in more detail, wherein channel state measurement is adopted as a non-limiting example for descriptive purposes.

Basically, it is assumed herein that the basic measurement principle according to current specifications of LTE Release-10 is adopted for the exemplary embodiments of the present invention. Accordingly, in the exemplary embodiments of the present invention described herein, a channel measurement has a CQI, and a PMI and RI if more than one port is configured. Further, the measurement result will be reported from the terminal to the instructing transmission point according to the basic principle according to current specifications of LTE Release-10.

In the acquisition operation 210 or 310, one or more CSI-RS patterns (which may also be referred to as CSI-RS symbols or merely as reference symbols) from one cell or multiple cells are acquired at the transmission point. When a respective procedure is performed at a macro-cell type transmission point of a cell in question, such acquisition may e.g. be accomplished in cooperation with one or more micro-cell type transmission points of said cell in question and/or one or more macro-/micro-cell type transmission points of one or more neighboring cells of said cell in question. The thus acquired CSI-RS pattern or patterns build the basis for the subsequent configuration operation 220 or 320.

In the configuration operation 220 or 320, specific CRS/CSI-RS ports may be picked (i.e. selected) from the acquired CSI-RS pattern or patterns, i.e. specific CRS/CSI-RS ports may be picked (i.e. selected) from the corresponding one or multiple cells. Thereby, a CSI measurement set is configured, in which at least two CSI measurement patters are established, each including a certain number of the picked (i.e. selected) CRS/CSI-RS ports. These at least two CSI measurement patters are then used in the subsequent operations for implementing CSI measurements based on the at least two CSI measurement patters including respective sets of CRS/CSI-RS ports being arbitrarily picked (i.e. selected) from the acquired CSI-RS pattern or patterns from one or multiple cells.

Accordingly, multiple CSI measurements can be configured (based on ports from one or multiple cells) for a terminal within one cell. This means that even within one cell more measurements (including inter-/cross cell measurements and/or intra-cell parallel measurements) can be configured. This is specifically useful when the terminal does not support carrier aggregation functions.

Further, measurements can be configured (based on ports from one or multiple cells) in an inter-RS pattern. That is to say, a channel measurement set can configure a CRS-based channel measurement and a CSI-RS-based channel measurement. In such case, one or more common reference signals (i.e. UE-specific reference signals for PDSH demodulation or the like) can be configured and combined in one of the channel measurement patterns, and one or more CSI reference signals (i.e. cell-specific reference signals for CSI measurement or the like) can be configured and combined in another one of the channel measurement patterns. Also, any one of the channel measurement patterns can include a configuration of a combined CRS and CSI-RS pattern, respectively. Thereby, a combined CRS/CSI-RS-based channel measurement can be configured.

For example, the two or more CSI-RS patterns from a cell in question, two or more CSI-RS patterns from different neighboring cells of a cell in question, or one or more CSI-RS patterns of a cell in question and one or more CSI-RS patterns from different neighboring cells of a cell in question may be acquired, thus building the basis for establishing a CSI measurement configuration and implementing multiple CSI measurements based thereon. When acquiring two or more CSI-RS patterns from a cell in question, intra-cell parallel CSI measurements may be realized, when acquiring two or more CSI-RS patterns from different neighboring cells of a cell in question, inter-/cross cell CSI measurements may be realized, and when acquiring one or more CSI-RS patterns of a cell in question and one or more CSI-RS patterns from different neighboring cells of a cell in question, a combination of intra-cell parallel CSI measurements and inter-/cross cell CSI measurements may be realized.

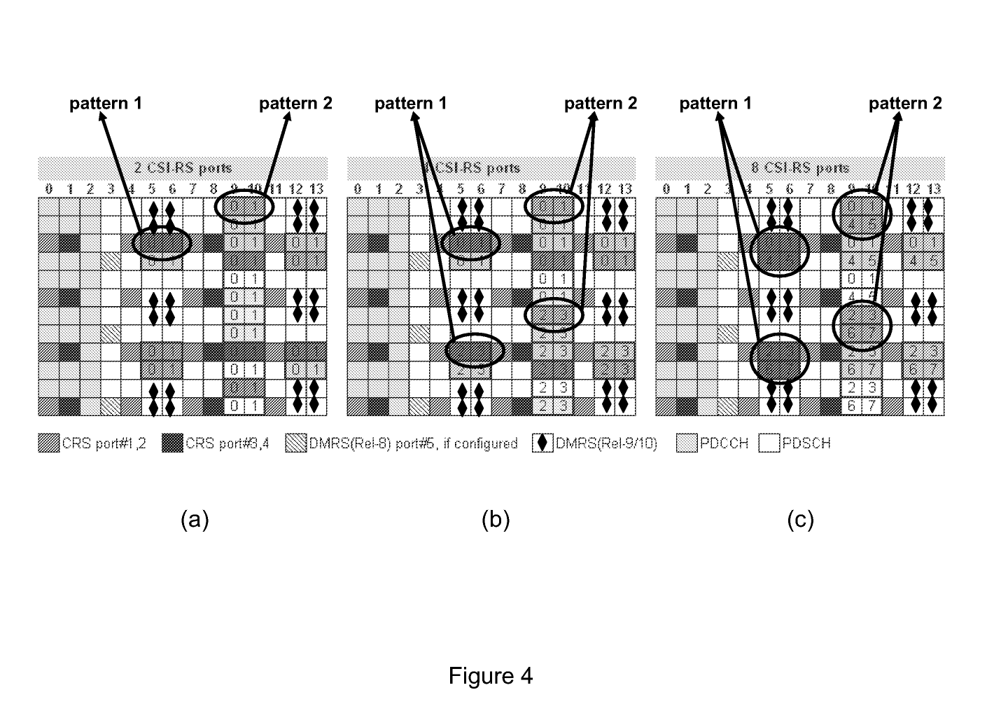

FIG. 4 shows a schematic diagram illustrating various mappings of reference signal patterns in a resource space according to exemplary embodiments of the present invention.

Generally, it is noted that each CSI-RS pattern defines ports subject to channel measurement in that each bit in a CSI-RS pattern indicates a set of a predefined number of ports to be measured, wherein the predefined number corresponds to the number of antennas of a transmission point in question. For example, for a transmission point having two (transmit) antennas, each bit in a corresponding CSI-RS pattern indicated two ports or resource elements in a resource space.

In FIG. 4, the illustrated resource space may be assumed to be spanned by a time axis and subcarrier/frequency axis. Accordingly, each block, i.e. each resource element, may represent an OFDM symbol occurring at a particular time and on a particular subcarrier in the time-frequency resource space.

In FIG. 4, three non-limiting examples of mappings are illustrated, wherein FIG. 4(a) relates to an example of a transmission point with two (transmit) antennas (i.e. each CSI-RS pattern bit representing two ports or resource elements), FIG. 4(b) relates to an example of a transmission point with four (transmit) antennas (i.e. each CSI-RS pattern bit representing four ports or resource elements), and FIG. 4(c) relates to an example of a transmission point with eight (transmit) antennas (i.e. each CSI-RS pattern bit representing eight ports or resource elements). In the 2 CSI-RS port example of FIG. 4(a), each pattern is constituted by a group of two ports or resource elements denoted by a set [0, 1] (and at most 20 such groups or patterns exist in the exemplary resource space). In the 4 CSI-RS port example of FIG. 4(b), each pattern is constituted by a group of four ports or resource elements denoted by a set [0, 1, 2, 3] (and at most 10 such groups or patterns exist in the exemplary resource space). In the 8 CSI-RS port example of FIG. 4(c), each pattern is constituted by a group of eight ports or resource elements denoted by a set [0, 1, . . . , 7] (and at most 5 such groups or patterns exist in the exemplary resource space).

According to exemplary embodiments of the present invention, a CSI measurement set may be configured by using the two patterns indicated as patterns 1 and 2 in any one FIGS. 4(a), 4(b) and 4(c). Accordingly, the resource elements of the two indicated patterns in any one FIGS. 4(a), 4(b) and 4(c) may exemplarily be utilized as ports for selection and combination purposes for establishing at least two CSI measurement patterns corresponding to at least to CSI measurements to be instructed and performed accordingly.

In a first exemplary scenario, CSI port patterns 1 and 2 may be used in a CSI measurement set, and an individual calculation based on a corresponding PMI/CQI/RI selection (i.e. two calculations of 2 transmit antenna ports each) may be performed thereon.

In a second exemplary scenario, CSI port patterns 1 and 2 may be grouped, and a joint calculation based on a corresponding PMI/CQI/RI selection (i.e. a calculation of 4 transmit antenna ports resulting from an addition of the 2 transmit antenna ports of each pattern) may be performed thereon.

Stated in other words, regarding a multiple measurement configuration in one cell, a non-limiting example could be to use CSI RS port pattern 1 as a first CSI measurement pattern in a CSI measurement set configuration, and CSI RS port pattern 2 as a second CSI measurement pattern in a CSI measurement set configuration.

Further, in the configuration operation 220 or 320, each port in the channel measurement set may be marked as puncture or non-puncture port. By way of such marking, the applicability of ports or resource elements, which correspond to ports or resource elements for CSI measurement, for a physical downlink channel (such as the PDSCH) may be specified. Accordingly, a puncture port indicates that a resource element corresponding to said port is not used for a physical downlink channel (such as the PDSCH), and/or a non-puncture port indicates that a resource element corresponding to said port is used for a physical downlink channel (such as the PDSCH).

By way of such puncturing, i.e. a corresponding marking of ports as non-/puncture ports, a transmission point may let a terminal know which port or resource element (RE) is used for data transmission. Specifically, the terminal may be made aware of the fact that a resource element (RE) corresponding to a puncture port is not used for e.g. the PDSCH, even if it is another cell that is doing the transmission. So, basically it is indicate that the PDSCH RE corresponding to the measurement RE is muted.

For example, if a port in question is a non-puncture port, then the port is not punctured, if e.g. the PDSCH is not transmitted from a corresponding transmission point or cell. If a port in question is a puncture port, then the port is punctured, if e.g. the PDSCH is transmitted from a corresponding transmission point or cell.

Stated in other terms, a data transmission on related resource elements (such as OFDM symbols) may be assumed to be punctured, if the port is marked as a puncture port. Thereby, a puncture port means that, at the UE (being instructed with a corresponding channel measurement set with the punctured port), the UE PDSCH transmission (e.g. on this port) shall puncture out the corresponding resource element (such as OFDM symbol) so as to protect this reference signal.

Thereby, such puncturing operation may constitute a reasonable assumption for the terminal as to which point or port or cell e.g. the PDSCH is transmitted from.

Further, in the configuration operation 220 or 320, each port in the channel measurement set may be assigned a cell identifier (which is quite long) or a cell index (which is a quite short mapping, e.g. with 3 bits, which is created when a secondary cells is configured). For example, the cell identifier (i.e. the cell ID) may be assigned to ports of transmission points in the same cell (while ports from the same cell do not need to be assigned a cell identifier), and/or the cell index may be assigned to ports of transmission points in different cells. In this regard, the cell index may represent a carrier aggregation parameter for indexing serving cells. Accordingly, the carrier aggregation framework may be reused, and it may be assumed that RS ports used in a CSI measurement set are from either PCell or a set of configured SCells. This means that the cell index used in RRC specification to index serving cells can be used to indicate which cell the RS port needed/configured for CSI measurement is coming from. State din other words, the cell index in the Pcell/Scell configuration according to the carrier aggregation framework may be used in exemplary embodiments of the present invention.

According to exemplary embodiments of the present invention, the CSI measurement set configuration may be established or represented in the following form, and may be communicated (for/in CoMP) by way of RRC signaling in such form.

### CSI Measurement Configuration:

```
{ RS port list
  RS port #1
  { cell-index,
      Port-index,
      Port-subframe-config,
      Port-type (CSI-RS/CRS),
      Pwr-offset,
      Port-puncture (yes/no) }
  RS port #2
  ...
  RS port #n
Feedback mode
Zero-Tx power CSI-RS
}
```

In the feedback operation 350, various types of feedback may be reported. For example, the feedback or report regarding an instructed channel measurement may comprise one or more of a measured CQI for ports of the respective channel measurement pattern, a measured CSI for ports of the respective channel measurement pattern, and a RRM report for ports of the respective channel measurement pattern.

Further, in the feedback operation 350, various feedback configurations may be switched e.g. in a terminal-selective manner. According to exemplary embodiments of the present invention, the feedback operation may be as follows.

In the case that no inter-/cross-cell CSI measurements are configured and there is only one measurement per serving cell, a corresponding feedback according to specifications of LTE Release-10 may be provided. Such feedback corresponds to a per-cell individual feedback in inter-cell CoMP or a joint feedback in intra-cell CoMP.

In the case that inter-/cross cell CSI measurements are defined but still only one measurement per serving cell is configured, a corresponding feedback according to specifications of LTE Release-10 may be provided. Such feedback corresponds to a joint feedback in inter-cell CoMP.

In the case that multiple CSI-RS measurements within one cell (including inter-/cross cell measurements and/or intra-cell parallel measurements) are configured, a periodic or aperiodic feedback according to exemplary embodiments of the present invention may be provided.

On the one hand, a periodic feedback or reporting regarding the configured channel measurement set may be provided. Such periodic feedback or reporting may be realized in a time multiplex manner on an uplink control channel.

For example, as the PUCCH configuration is cell specific, CSI measurements may be marked as to whether or not they should be considered for PUCCH reporting, including the constraint that only one CSI measurement per cell can be marked for PUCCH reporting. For one measurement set, CSI feedback may be multiplexed in the time domain, or reported at one subframe by extending PUCCH. Regarding the time multiplexing solution, a multiple serving cell feedback mechanism of carrier aggregation according to specifications of LTE Release-10 may be adopted.

As PUCCH reporting is periodic and resource limited, a time division multiplexing mechanism for one CSI measurement may be presented, wherein a required number of reporting items is distributed throughout an available reporting period by way of defining respective offsets for the individual reporting items. For example, a CSI report of three cells within the CSI measurement set may be fed back within one CSI measurement, and different offsets could be used to report the different CSI reports such that the first CSI report is included in the initial third of the available period, the second CSI report is included in the middle third of the available period, and the third CSI report is included in the last third of the available period.

On the other hand, an aperiodic feedback or reporting regarding the configured channel measurement set may be provided. Such aperiodic feedback or reporting may be realized in a predetermined information element on an uplink shared channel, and may be triggered by the terminal.

In this regard, an information element or field being defined according to specifications of LTE Release-10 may be reinterpreted and thus adopted accordingly. For example, the “CSI request field” may be reinterpreted and adopted for aperiodic CSI reporting, while a set of CSI measurements is to be referred to instead of reporting to a set of serving cells.

As PUSCH reporting is aperiodic, an aperiodic indication could be (re-)used as indicated above.

For example, the aperiodic configuration of the “CSI request field” in the PDCCH, which is defined according to Table 1 below, could be reinterpreted as aperiodic CSI (CoMP) configuration, as defined according to Table 2 below.

TABLE 1

| Value | Description |
|---|---|
| ‘00’ | No aperiodic CSI report is triggered |
| ‘01’ | Aperiodic CSI report is triggered for serving cell ^{c} |
| ‘10’ | Aperiodic CSI report is triggered for a 1st set of |
| | serving cells configured by higher layers |
| ‘11’ | Aperiodic CSI report is triggered for a 2nd set of |
| | serving cells configured by higher layers |

TABLE 2

| Value | Description |
|---|---|
| ‘00’ | No aperiodic CSI report is triggered |
| ‘01’ | Aperiodic CSI report is triggered for serving cell ^{c} |
| ‘10’ | Aperiodic CSI report is triggered for a 1st set of CSI- |
| | RS measurements configured by higher layers |
| ‘11’ | Aperiodic CSI report is triggered for a 2nd set of CSI - |
| | RS measurements configured by higher layers |

It is noted that potential updates on codebooks used to generate the PMI are not discussed herein. Yet, in case CSI measurements are configured across cells, it may be expected that even though only 4 or 8 ports are configured in total across the cells, new codebooks could be needed to handle the lack of correlation among ports from different transmission points.

In view of the above, exemplary embodiments of the present invention may provide for the following effects.

A generic CSI measurement configuration may be provided, which can extend flexibility to handle CSI measurements based on ports from different cells and to also handle multiple CSI measurements within one cell.

A flexible and simple scheme for CSI measurement configuration and/or CSI feedback may be provided, which is capable of supporting CoMP in terms of various transmission schemes/modes and scenarios.

Inter-/cross-cell channel measurements based on CSI-RS ports belonging to different cells and/or intra-cell parallel (multiple) channel measurements within one cell for one UE may be enabled.

A CSI-RS design, including a unified feedback framework, may be provided, which enables CSI-RS measurements from multiple cells simultaneously without PDSCH interference.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

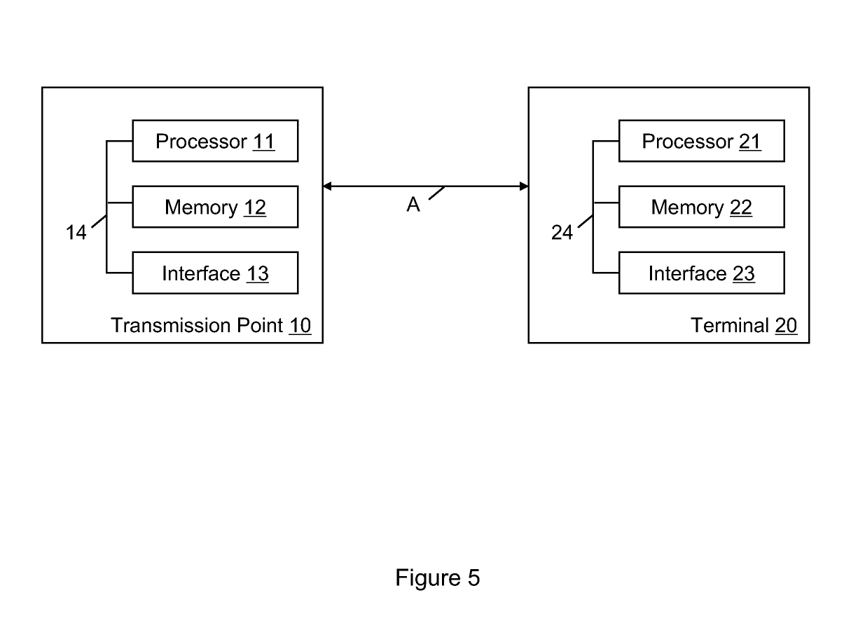

Respective exemplary embodiments of the present invention are described below referring to FIG. 5, while for the sake of brevity reference is made to the detailed description of respective corresponding methods and operations according to FIGS. 2 to 4 as well as the underlying system architectures according to FIG. 1.

In FIG. 5 below, the solid line blocks are basically configured to perform respective operations as described above. The entirety of solid line blocks are basically configured to perform the methods and operations as described above, respectively. With respect to FIG. 5, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 5, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 5 shows a schematic diagram of apparatuses according to exemplary embodiments of the present invention. As mentioned above, it is noted that the illustration of (electronic) devices according to FIG. 5 is simplified.

In view of the above, the thus described apparatuses 10 and 20 are suitable for use in practicing the exemplary embodiments of the present invention, as described herein.

The thus described apparatus 10 may represent a (part of a) transmission point such a macro-cell or micro-cell type transmission point, e.g. a base station or access node, as described above, and may be configured to perform a procedure and/or exhibit a functionality as described in conjunction with any one of FIGS. 2 and 3. The thus described apparatus 20 may represent a (part of a) terminal, e.g. a UE, as described above, and may be configured to perform a procedure and/or exhibit a functionality as described in conjunction with any one of FIGS. 2 and 3.

As indicated in FIG. 5, according to exemplary embodiments of the present invention, each of the apparatuses comprises a processor 11/22, a memory 12/22 and an interface 13/23, which are connected by a bus 14/24 or the like, and the apparatuses may be connected via a link A.

The processor 11/21 and/or the interface 13/23 may also include a modem or the like to facilitate communication over a (hardwire or wireless) link, respectively. The interface 13/23 may include a suitable transceiver coupled to one or more antennas or communication means for (hardwire or wireless) communications with the linked or connected device(s), respectively. The interface 13/23 is generally configured to communicate with at least one other apparatus, i.e. the interface thereof.

The memory 12/22 may store respective programs assumed to include program instructions or computer program code that, when executed by the respective processor, enables the respective electronic device or apparatus to operate in accordance with the exemplary embodiments of the present invention. Further, the memories 12/22 may store one or more of the aforementioned parameters, traffic, data and information, such as a CSI-RS patterns or configurations.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “processor configured to [cause the apparatus to] perform xxx-ing” is construed to be equivalent to an expression such as “means for xxx-ing”).

According to exemplary embodiments of the present invention, the apparatus 10 or its processor 11 is configured to perform acquiring one or more reference signal patterns for channel measurement, each reference signal pattern defining predefined number of ports subject to channel measurement, configuring a channel measurement set for a terminal by selecting ports out of the acquired one or more reference signal patterns and combining the selected ports in at least two channel measurement patterns, and instructing channel measurements at the terminal based on the at least two channel measurement patterns in the configured channel measurement set.

According to exemplary embodiments of the present invention, the apparatus 10 or its processor 11 may be configured to perform one or more of:
marking each port in the channel measurement set as puncture or non-puncture port, wherein a puncture port indicates that a resource element corresponding to said port is not used for a physical downlink channel,
assigning a cell identifier or a cell index to each port, wherein the cell identifier is assigned to ports of transmission points in the same cell and the cell index representing a carrier aggregation parameter for indexing serving cells is assigned to ports of transmission points in different cells,
receiving, from the terminal, feedback regarding the instructed channel measurements, and configuring the channel measurement set based on the received feedback.

According to exemplary embodiments of the present invention, the apparatus 20 or its processor 21 is configured to perform receiving, from a transmission point, an instruction for channel measurements on the basis of a channel measurement set, and performing the instructed channel measurements based on at least two channel measurement patterns in the channel measurement set, each channel measurement pattern including a number of ports from one or more reference signal patterns for channel measurement, which are subject to channel measurement.

According to exemplary embodiments of the present invention, the apparatus 20 or its processor 21 may be configured to perform sending, to the transmission point, feedback regarding the instructed channel measurements.

According to exemplarily embodiments of the present invention, the processor 11/21, the memory 12/22 and the interface 13/23 may be implemented as individual modules, chips, chipsets, circuitries or the like, or one or more of them can be implemented as a common module, chip, chipset, circuitry or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

There are provided measures for flexible configuration of channel measurement, particularly in CoMP communication and/or CoMP-enabled heterogeneous network deployments. Such measures may exemplarily comprise acquiring one or more reference signal patterns for channel measurement, each reference signal pattern defining a predefined number of ports subject to channel measurement, configuring a channel measurement set for a terminal by selecting ports out of the acquired one or more reference signal patterns and combining the selected ports in at least two channel measurement patterns, and instructing channel measurements at the terminal based on the at least two channel measurement patterns in the configured channel measurement set.

The measures according to exemplary embodiments of the present invention may be applied for any kind of network environment, particularly in any kind of heterogeneous network environment, such as for example for those in accordance with 3GPP RAN2/RAN3 standards and/or 3GPP LTE standards of release 10/11/12/ . . . (LTE-Advanced and its evolutions).

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

### 3GPP 3rd Generation Partnership Project

### CA Cell/Carrier Aggregation

### CoMP Coordinated Multi-Point Transmission

### CQI Channel Quality Indicator

### CRS Common Reference Signal

### CSI Channel State Information

### DL Downlink

### DMRS Demodulation Reference Signal

HeNB Home evolved NodeB

### HNB Home NodeB

### IETF Internet Engineering Task Force

### MIMO Multiple-Input Multiple-Output

### OFDM Orthogonal Frequency Division Multiplexing

PCell Primary Cell in terms of CA

### PMI Precoding Matrix Indicator

### PDCCH Physical Downlink Control Channel

### PDSCH Physical Downlink Shared Channel

### PUCCH Physical Uplink Control Channel

### PUSCH Physical Uplink Shared Channel

### RI Rank Indicator

### RRC Radio Resource Control

### RRM Radio Resource Management

### RRH Remote Radio Head

### RS Reference Signal

SCell Secondary Cell in terms of CA

### UE User Equipment

UL Uplink

1. A method comprising
acquiring one or more reference signal patterns for channel measurement, each reference signal pattern defining a predefined number of ports subject to channel measurement,
configuring a channel measurement set for a terminal by selecting ports out of the acquired one or more reference signal patterns and combining the selected ports in at least two channel measurement patterns, and
instructing channel measurements at the terminal based on the at least two channel measurement patterns in the configured channel measurement set.

2. The method according to claim 1, wherein configuring the channel measurement set comprises
marking each port in the channel state measurement set as puncture or non-puncture port, wherein a puncture port indicates that a resource element corresponding to said port is not used for a physical downlink channel.

3. The method according to claim 1, wherein configuring the channel measurement set comprises
assigning a cell identifier or a cell index to each port.

4. The method according to claim 1, further comprising
receiving, from the terminal, feedback regarding the instructed channel measurements, and
configuring the channel measurement set based on the received feedback.

5. The method according to claim 4, wherein the feedback of an instructed channel measurement comprises one or more of a measured channel quality indicator for ports of the respective channel measurement pattern, a measured channel state information for ports of the respective channel measurement pattern, and a radio resource management report for ports of the respective channel measurement pattern.

6. The method according to claim 4, wherein the feedback is received as one of individual feedback in inter-cell coordinated multi-point communication, joint feedback in inter-cell coordinated multi-point communication, joint feedback in intra-cell coordinated multi-point communication, periodic reporting regarding the configured channel measurement set in a time multiplex manner on an uplink control channel, and aperiodic reporting regarding the configured channel measurement set in a predetermined information element on an uplink shared channel.

7. The method according to claim 1, wherein
the method is operable at or by a macro cell transmission point of a network deployment, and/or
the method is operable in a heterogeneous network deployment comprising macro cells and micro cells, and/or
channel measurement relates to at least one of channel state measurement and channel quality measurement.

8. A method comprising
receiving, from a transmission point, an instruction for channel measurements on the basis of a channel measurement set, and
performing the instructed channel measurements based on at least two channel measurement patterns in the channel measurement set, each channel measurement pattern including a number of ports from one or more reference signal patterns for channel measurement, which are subject to channel measurement.

9. The method according to claim 8, wherein the channel measurement set comprises
a marking of each port in the channel measurement set as puncture or non-puncture port, wherein a puncture port indicates that a resource element corresponding to said port is not used for a physical downlink channel.

10. The method according to claim 8, wherein the channel measurement set comprises
an assignment of a cell identifier or a cell index to each port.

11. The method according to claim 8, further comprising
sending, to the transmission point, feedback regarding the instructed channel measurements.

12. The method according to claim 11, wherein the feedback of an instructed channel measurement comprises one or more of a measured channel quality indicator for ports of the respective channel measurement pattern, a measured channel state information for ports of the respective channel measurement pattern, and a radio resource management report for ports of the respective channel measurement pattern.

13. The method according to claim 11, wherein the feedback is transmitted as one of individual feedback in inter-cell coordinated multipoint communication, joint feedback in inter-cell coordinated multi-point communication, joint feedback in intra-cell coordinated multi-point communication, periodic reporting regarding the configured channel measurement set in a time multiplex manner on an uplink control channel, and aperiodic reporting regarding the configured channel measurement set in a predetermined information element on an uplink shared channel.

14. The method according to claim 8, wherein
the method is operable at or by a terminal of a network deployment, and/or the method is operable in a heterogeneous network deployment comprising macro cells and micro cells, and/or
channel measurement relates to at least one of channel state measurement and channel quality measurement.

15. An apparatus comprising
an interface configured to communicate with at least another apparatus, and a processor configured to cause the apparatus to perform:
acquiring one or more reference signal patterns for channel measurement, each reference signal pattern defining a predefined number of ports subject to channel measurement,
configuring a channel measurement set for a terminal by selecting ports out of the acquired one or more reference signal patterns and combining the selected ports in at least two channel measurement patterns, and
instructing channel measurements at the terminal based on the at least two channel measurement patterns in the configured channel measurement set.

16. The apparatus according to claim 15, wherein processor is further configured to cause the apparatus to perform:
marking each port in the channel measurement set as puncture or non-puncture port, wherein a puncture port indicates that a resource element corresponding to said port is not used for a physical downlink channel.

17. The apparatus according to claim 15, wherein processor is further configured to cause the apparatus to perform:
assigning a cell identifier or a cell index to each port.

18. The apparatus according to claim 15, wherein processor is further configured to cause the apparatus to perform:
receiving, from the terminal, feedback regarding the instructed channel measurements, and
configuring the channel measurement set based on the received feedback.

19. The apparatus according to claim 18, wherein the feedback of an instructed channel measurement comprises one or more of a measured channel quality indicator for ports of the respective channel measurement pattern, a measured channel state information for ports of the respective channel measurement pattern, and a radio resource management report for ports of the respective channel measurement pattern.

20. The apparatus according to claim 18, wherein the feedback is receivable as one of individual feedback in inter-cell coordinated multi-point communication, joint feedback in inter-cell coordinated multi-point communication, joint feedback in intra-cell coordinated multi-point communication, periodic reporting regarding the configured channel measurement set in a time multiplex manner on an uplink control channel, and aperiodic reporting regarding the configured channel measurement set in a predetermined information element on an uplink shared channel.

21. The apparatus according to claim 15, wherein
the apparatus is operable as or at a macro cell transmission point of a network deployment, and/or
the apparatus is operable in a heterogeneous network deployment comprising macro cells and micro cells, and/or
channel measurement relates to at least one of channel state measurement and channel quality measurement.

22. An apparatus comprising
an interface configured to communicate with at least another apparatus, and
a processor configured to cause the apparatus to perform:
receiving, from a transmission point, an instruction for channel measurements on the basis of a channel measurement set, and
performing the instructed channel measurements based on at least two channel measurement patterns in the channel measurement set, each channel measurement pattern including a number of ports from one or more reference signal patterns for channel measurement, which are subject to channel measurement.

23. The apparatus according to claim 22, wherein the channel measurement set comprises
a marking of each port in the channel measurement set as puncture or non-puncture port, wherein a puncture port indicates that a resource element corresponding to said port is not used for a physical downlink channel.

24. The apparatus according to claim 22, wherein the channel measurement set comprises
an assignment of a cell identifier or a cell index to each port.

25. The apparatus according to claim 22, wherein processor is further configured to cause the apparatus to perform:
sending, to the transmission point, feedback regarding the instructed channel measurements.

26. The apparatus according to claim 25, wherein the feedback of an instructed channel measurement comprises one or more of a measured channel quality indicator for ports of the respective channel measurement pattern, a measured channel state information for ports of the respective channel measurement pattern, and a radio resource management report for ports of the respective channel measurement pattern.

27. The apparatus according to claim 25, wherein the feedback is transmittable as one of individual feedback in inter-cell coordinated multipoint communication, joint feedback in inter-cell coordinated multi-point communication, joint feedback in intra-cell coordinated multi-point communication, periodic reporting regarding the configured channel measurement set in a time multiplex manner on an uplink control channel, and aperiodic reporting regarding the configured channel measurement set in a predetermined information element on an uplink shared channel.

28. The apparatus according to claim 22, wherein
the apparatus is operable as or at a terminal of a network deployment, and/or
the apparatus is operable in a heterogeneous network deployment comprising macro cells and micro cells, and/or
channel measurement relates to at least one of channel state measurement and channel quality measurement.

29. A computer program product comprising computer-executable computer program code which, when the program is run on a computer, is configured to cause the computer to carry out the method according to claim 1.

30. The computer program product according to claim 29, wherein the computer program product comprises a computer-readable medium on which the computer-executable computer program code is stored, and/or wherein the program is directly loadable into an internal memory of the processor.
